(19) United States
(12) Patent Application Publication
(10) Pub. No.: US 2014/0321500 A1
(43) Pub. Date: Oct. 30, 2014

(54) METHOD BASED ON INSPECTION TO AVOID EXCESSIVE MAINTENANCE OF AN AUTOMOBILE COOLING SYSTEM

(71) Applicant: MIT AUTOMOBILE SERVICE COMPANY LIMITED, YANTAI (CN)

(72) Inventors: Zhixin XIAO, YANTAI (CN); Qin WEI, YANTAI (CN); Zhiliang WEI, YANTAI (CN); Qinglu CUI, YANTAI (CN)

(73) Assignee: MIT AUTOMOBILE SERVICE COMPANY LIMITED, YANTAI (CN)

(21) Appl. No.: 14/264,035

(22) Filed: Apr. 28, 2014

(30) Foreign Application Priority Data
Apr. 27, 2013 (CN) 201310152455.0

(51) Int. Cl. G01N 25/04

(52) U.S. Cl. CPC G01N 25/04
USPC 374/16

(57) ABSTRACT

The purpose of this invention is to overcome the defect of the present judgment method for automobile cooling system. It is an inspection method based on the aging degree of lubricating oil of the oil reservoir sensor. The invitation is a method based on the inspection to avoid excessive maintenance of the automobile cooling system, its feature: With a type of antifreeze freezing point detection module and main controller, and etc, to detect the freezing point of the antifreeze before maintenance, it will show the degree of aging. If the result shows no need to change the antifreeze, then keep using to avoid excessive maintenance, which will reduce the maintenance fee and save resources. The main controller checks the records like maintenance interval, maintenance content, travelled distance, and etc. These records could be auxiliary judgment conditions. Main controller and antifreeze freezing point detection module 1 are connected by cable.

### FIELD OF THE INVENTION

This invention will prevent the automobile cooling system from excessive maintenance, which is based on inspection.

### BACKGROUND

The cooling system is important part of the motor. Bad cooling will increase the oil computation, and shorten the motor's life. Due to economic profit and the present inspection method, the cooling system is maintained at regular intervals, without inspection on antifreeze. The excessive maintenance is very common, which increases the economic burden, and also result in resource waste.

### SUMMARY OF THE INVENTION

The system includes antifreeze freezing point inspection module and a main controller, and may include other related OBD modules.

Antifreeze freezing point detection module includes optical sensor, total reflection lens module, control panel interface and monochromatic light source. The control panel Interface is connected with optical sensor and monochromatic light source by cable.

The main controller includes control panel, bar code scanning module, LCD touch screen, electrical pump and connection accessory, and related components. The main controller is connected with bar code scanning module, LCD touch screen, and electrical pump by cable. The connection accessory and electrical pump are connected by a conduit such as a pipeline.

The invention is a method based on the inspection to avoid excessive maintenance of the automobile cooling system, its key feature being: a type of antifreeze freezing point detection module, and main controller, and related components are used to detect the freezing point of the antifreeze before maintenance, it will show the degree of aging. If the result shows no need to change the antifreeze, then it outputs a keep using antifreeze indication to avoid excessive maintenance, which will reduce the maintenance fee and save resources.

The invention is a method based on the inspection to avoid excessive maintenance of the automobile cooling system, its other key feature being: The main controller checks the records like maintenance interval, maintenance content travelled distance, and other related data. These records could be auxiliary judgment conditions.

### BRIEF DESCRIPTION OF THE DRAWINGS

FIG. 1 is the system theory chart.

FIG. 2 is the antifreeze freezing point inspection method flow chart.

FIG. 3 is the invention assists preventing excessive maintenance flow chart.

The following call out list of elements can be a useful guide in referencing the elements of the drawings.

1 Antifreeze Freezing Point Detection Module

2 Total Reflection Lens Module

3 Optical Sensor

4 Control Panel Interface

5 Monochromatic Light Source

6 Main Controller

7 Control Panel

8 Led Touch Screen

9 Bar Code Scanning Module

10 Electrical Pump

11 Connection Accessory

### DETAILED DESCRIPTION OF THE PREFERRED EMBODIMENT

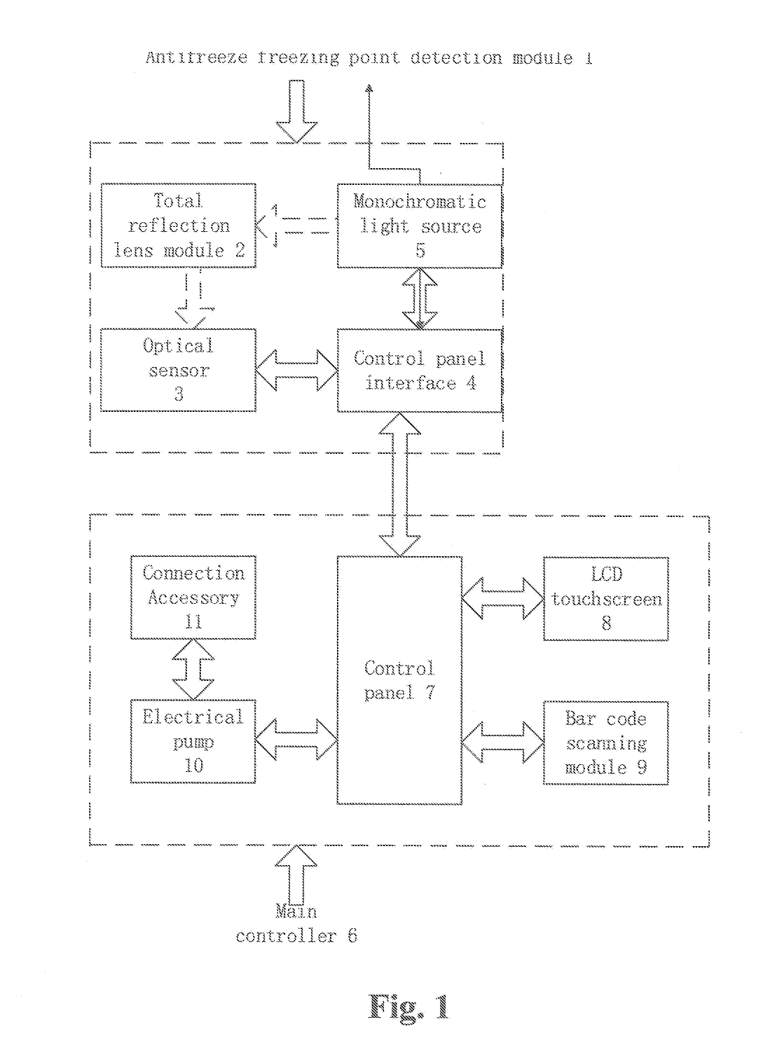

FIG. 1 is the system theory chart. Antifreeze freezing point detection module 1 includes optical sensor 3, total reflection lens module 2, control panel interface 4 and monochromatic light source 5. Control panel interface 4 is connected with optical sensor 5 and monochromatic light source 8 by cable. Monochromatic light source 8 supplies a light source for total reflection lens module 2. Optical sensor 3 receives the light from total reflection lens module 2. Main controller 6 includes control panel 7, bar code scanning module 9, LCD touch screen 8, electrical pump 10 and connection accessory 11, etc. Main controller 7 is connected with bar code scanning module 9, LCD touch screen 8, and electrical pump 10 by a cable. The connection accessory 11 and electrical pump 10 are connected by a pipeline. Main controller 6 and antifreeze freezing point detection module 1 are connected by cable.

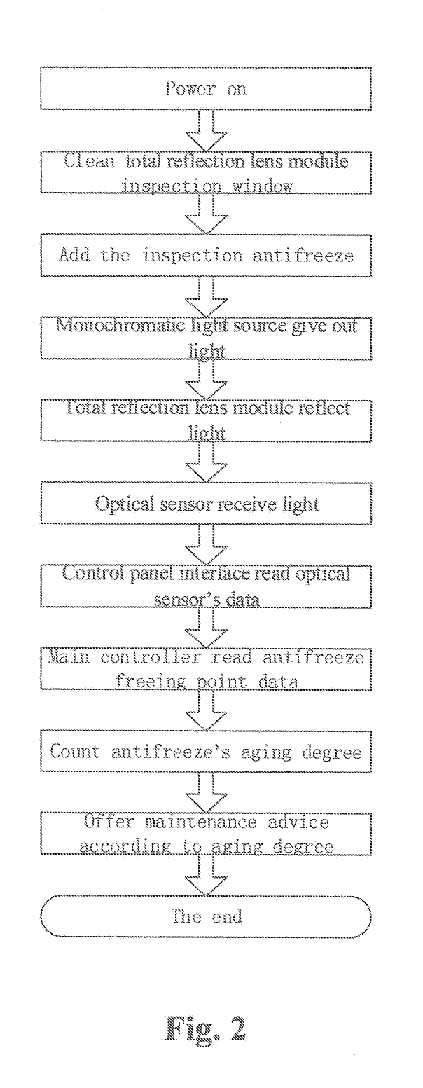

FIG. 2 is the antifreeze freezing point inspection method flow chart. To operate, power on to initiation, clean total reflection lens module 2 inspection window, and add the inspection antifreeze. Control panel interface 4 makes monochromatic light source 5 to give out light. Total reflection module 2 reflects the light to optical sensor 3. Main controller 7 communicates with control panel interlace 4 by a serial interface, to read the antifreeze freezing point data, and compare the data with the standard data to count the aging degree of the antifreeze. The aging degree data will tell us whether we need to change the antifreeze or not.

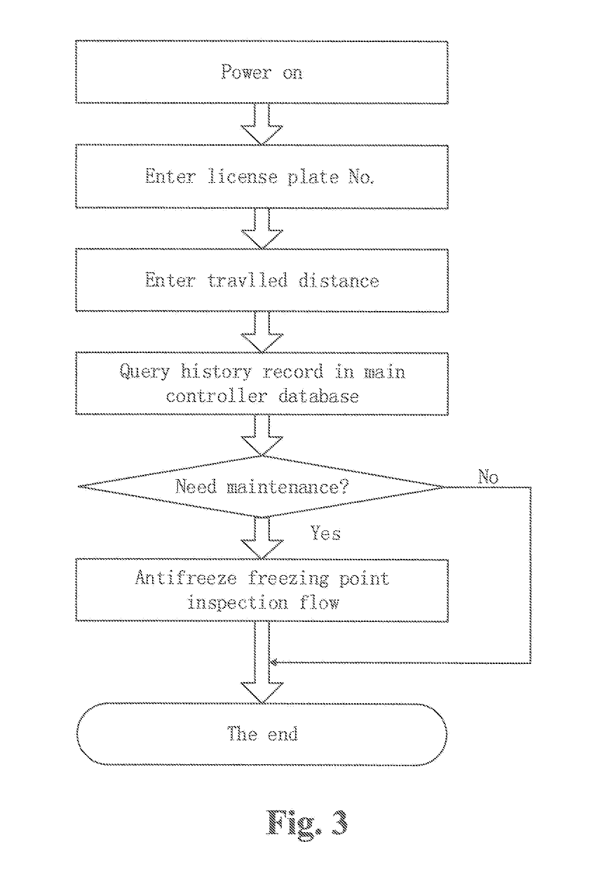

FIG. 3 is the preventing excessive maintenance flow chart. To operate, power on to initiation, enter the license plate number and traveled distance. Main controller 6 will query history record to check the maintenance content, travelled distance intervals and maintenance intervals, and other data and information. If these data do not support criteria to perform a maintenance, the device regards the maintenance as an excessive one and outputs an excessive output to supply an excessive output indicator such as a light. If these data do support, then we will apply item 2 to avoid excessive maintenance.

1. A method based on the inspection to avoid excessive maintenance of the Automobile cooling system, its feature: With a type of antifreeze freezing point detection module (1) and main controller (6), etc, to detect the freezing point of the antifreeze before maintenance, it will show the degree of aging. If the result shows no need to change the antifreeze, then keep using to avoid excessive maintenance, which will reduce the maintenance fee and save the resource.

2. Antifreeze freezing point detection module (1) includes optical sensor (3), total reflection lens module (2), control panel interface (4) and monochromatic light source (5); Main controller (6) includes control panel (7), bar code scanning module (9), LCD much screen (8), electrical pump (10) and connection accessory (11) etc; Main controller (6) and Antifreeze freezing point detection module (1) are connected by cable.

3. The feature of this method is that, the main controller checks the records like maintenance interval, maintenance content, travelled distance, etc. These records could be auxiliary judgment conditions.
